(19) United States
(12) Patent Application Publication
(10) Pub. No.: US 2022/0108380 A1
(43) Pub. Date: Apr. 7, 2022

(54) METHODS AND SYSTEMS FOR PROCESSING HIGH FREQUENCY REQUESTS WITH LIMITED THROUGHPUT

(71) Applicant: Shopify Inc., Ottawa (CA)

(72) Inventors: Peter BILOTTA, Kitchener (CA); Dennis HO, Rockcliffe (CA)

(73) Assignee: Shopify Inc., Ottawa, ON (CA)

(21) Appl. No.: 17/062,881

(22) Filed: Oct. 5, 2020

(51) Int. Cl. G06Q 30/06; H04L 29/08

(52) U.S. Cl. CPC G06Q 30/0637; H04L 67/32; G06Q 30/0607; G06Q 30/0631

(57) ABSTRACT

Methods and systems for processing high frequency requests The method may include receiving, by a computing system, a product request for an item; appending the product request to an ordered queue of requests for processing; determining a likelihood of completion value for the product request; and, when the likelihood of completion value is less than a threshold level, identifying an alternative offer and generating and sending, to a customer device, data regarding the alternative offer.

### FIELD

The present disclosure relates to processing high frequency requests by computer systems in the context of limited throughput in which requests may be queued for processing by a computer system, such as in the context of a flash sale event in an e-commerce system.

### BACKGROUND

In many computing systems, a high volume of requests may be received for processing in a short time window. Throughput and processing of those requests may be limited or throttled, either intentionally to avoid overload or due to limited capacity. There may be reasons in some cases to intentionally limit throughput, such as if certain other operations need time to occur during the processing or if excessive speed introduces other concerns or vectors of attack.

High volume or high frequency requests may occur, for example, in an e-commerce system during periods of high demand. This can occur in the case of a flash sale or high demand product launch, or other such event. In an e-commerce system, product requests may be queued for processing in the order in which they are received or in tranches. Processing of those requests may include payment processing, inventory-tracking processes, shipping query processes, fraud detection, etc. A fraud detection event may include reversing payment and/or initiating a re-stocking event to update inventory.

In many cases, requests received exceed available inventory for the requests, and once inventory is determined to be exhausted, response messages or notifications may be sent to queued unfulfilled requests, such as a failure or out-of-stock notification.

### BRIEF DESCRIPTION OF THE DRAWINGS

Embodiments will be described, by way of example only, with reference to the accompanying figures wherein:

FIG. 1 is a block diagram of an example e-commerce platform, according to one embodiment;

FIG. 2 is an example of a home page of an administrator, according to one embodiment;

FIG. 3 shows, in block diagram form, one example of a system for handling queued requests;

FIG. 4 shows, in flowchart form, one example method of processing product requests with limited throughput;

FIG. 5 shows, in flowchart form, another example method of processing product requests with limited throughput; and

FIG. 6 shows, in flowchart form, yet a further example method of processing product requests with limited throughput.

### DETAILED DESCRIPTION

In one aspect, the present application describes a computer-implemented method of processing high frequency requests in a computing system. The method may include receiving, by the computing system, a product request for an item; appending the product request to an ordered queue of requests for processing; determining a likelihood of completion value for the product request; and, when the likelihood of completion value is less than a threshold level, identifying an alternative offer, and generating and sending, to a customer device, data regarding the alternative offer.

In some implementations, the method may further include receiving an acceptance message from the customer device and, as a result, removing the product request from the ordered queue. In some cases, the method further includes, in response to receiving the acceptance message, processing an alternative request for the alternative offer.

In some implementations, identifying the alternative offer may include determining that a completion probability with respect to the alternative offer exceeds a second threshold level.

In some implementations, identifying the alternative offer may be based, at least in part, on merchant-selected alternative offers and customer data retrieved from a data storage device in the computing system.

In some implementations, determining a likelihood of completion value may include determining the likelihood of completion value based on, at least, a queue position of the product request and an item inventory. In some cases, determining the likelihood of completion value is further based on at least one of a customer history, a cart abandonment rate, likelihood of completion values associated with requests earlier in the queue, an item purchase history, or an alternative product purchase history.

In some implementations, determining the likelihood of completion value may include determining respective likelihood of completion values for a subset of product requests in the queue and determining that the product request is associated with a lowest one of the respective likelihood of completion values.

In some implementations, identifying an alternative offer may include determining a probability of acceptance of the alternative offer for a subset of customers having pending product requests in the ordered queue, identifying a particular customer as having a highest probability of acceptance. In some cases, generating and sending includes generating and sending data regarding the alternative offer to the particular customer. In some cases, the probability of acceptance for each customer in the subset of customers is at least partly based on stored customer data regarding that customer.

In another aspect, the present application describes a computing system to process high frequency requests. The system may include one or more processors; memory storing customer data; and a processor-readable storage medium containing processor-executable instruction that, when executed by the one or more processors, are to cause the one or more processors to carry out the operations of one or more of the methods described herein.

In yet a further aspect, the present application describes a non-transitory computer-readable medium storing processor-executable instructions that, when executed, are to cause a processor to carry out the operations of one or more of the methods described herein.

For illustrative purposes, specific example embodiments will now be explained in greater detail below in conjunction with the figures.

Example e-Commerce Platform

In some embodiments, the methods disclosed herein may be performed on or in association with an e-commerce platform. Therefore, an example of an e-commerce platform will be described.

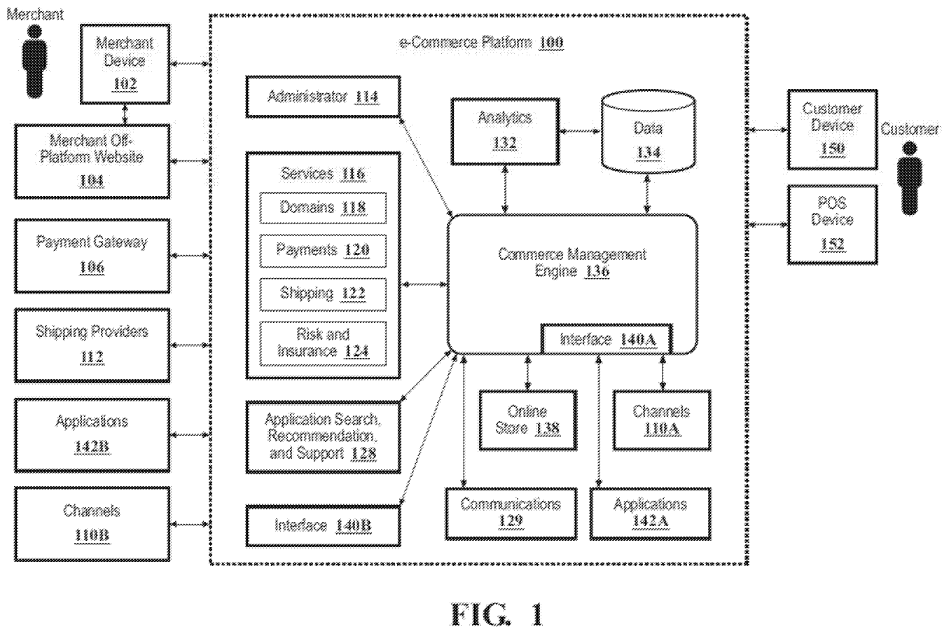

FIG. 1 illustrates an e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers (or “purchasers”) as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

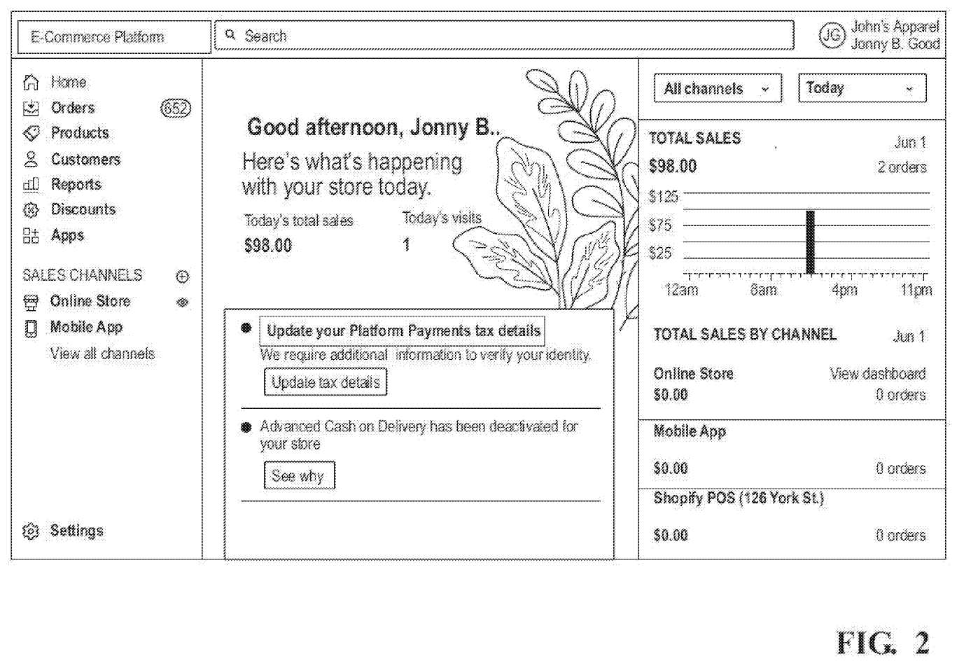

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for the communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a platform payment facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The platform payment facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the platform 100 or by a different party. In some embodiments, an application 142B may be provided by the same party providing the platform 100 or by a different party. The commerce management engine 136 may be configured for flexibility and scalability through portioning (e.g., sharing) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for the platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through an application search, recommendations, and support platform 128 or system. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide the application search, recommendation and support platform 128. The application search, recommendation and support platform 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the lifespan of a cart may be in the order of minutes, carts may be persisted to an ephemeral data store in some cases. However, in many implementations, while the customer session may only last minutes, the merchant and/or customer may wish to have the possibility of returning to a cart built in a previous session. Accordingly, the cart, e.g. the shopping cart data structure populated with product item data and a user identifier, may be stored in persistent memory on the platform 100.

In a typical session, a customer proceeds to checkout at some point after adding one or more items to their shopping cart. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer does not complete the transaction, the e-commerce platform 100 may retain the shopping cart data structure in memory so that the customer may return to the partially-completed cart in a subsequent session (e.g., in an abandoned cart feature).

Checkouts may calculate taxes and shipping costs based on the customer's shipping address. Checkout may delegate the calculation of taxes to a tax component and the calculation of shipping costs to a delivery component. A pricing component may enable merchants to create discount codes. Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Queued Request Handling

As noted above, in a variety of contexts, including e-commerce platforms, requests for an item or service may be queued for processing and/or fulfilment. Indeed, it is noted that while the following discussion is framed in relation to the example context of an e-commerce platform, the subject-matter of the present application is equally applicable in other contexts including those beyond e-commerce.

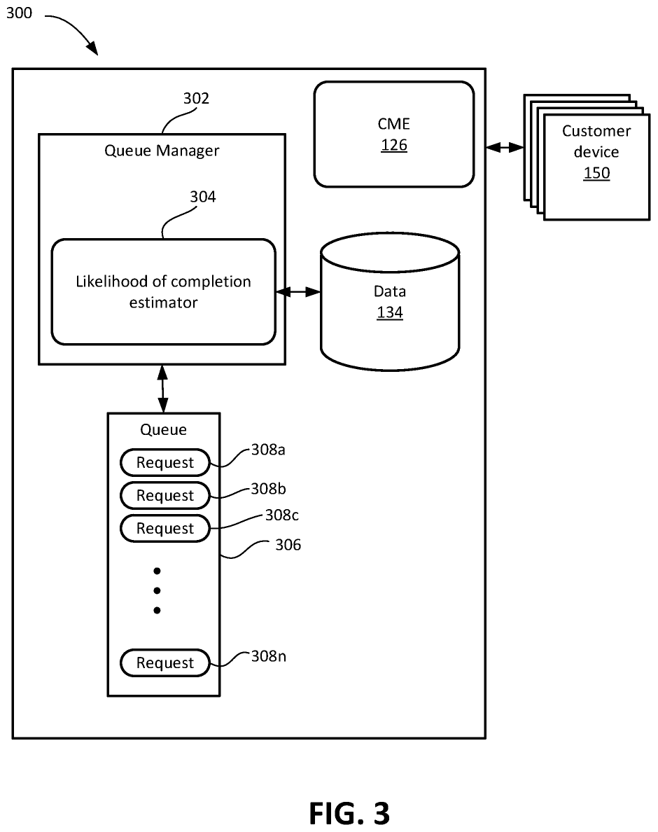

FIG. 3 shows, in block diagram form, one example of a system for handling queued requests. In this example, the system is an e-commerce platform 300. The e-commerce platform 300 may include the commerce management engine 136, the data repository 134, and various other components (not shown) described in connection with the e-commerce platform 100 depicted in FIG. 1.

A plurality of customer devices 150 connect with the e-commerce platform 300 to access online merchant products through one or more channels. The e-commerce platform 300 includes a queue manager 302 to handle incoming product requests and to manage the processing of those requests. The queue manager 302 may be implemented within the commerce management engine 136, as one of the services 116 (FIG. 1), as one of the applications 142A (FIG. 1), as a standalone application or service, or otherwise within the e-commerce platform 300. The queue manager 302 may be a process or job in some instances. The queue manager 302 may be initiated or launched in response to detection of high demand on the e-commerce platform 300 (e.g. more than a threshold number of active customer devices accessing the platform 300, or accessing a particular merchant channel, or receipt of more than a threshold number of product requests in a time window in connection with a particular product or merchant). In some cases the queue manager 302 may be initiated or otherwise enabled based on an anticipated demand, such as in anticipation of a high demand event, like a flash sale or other such event.

The queue manager 302 may maintain a queue 306, which in some cases may include a data structure or buffer in memory. The data structure may be implemented as a first-in-first-out buffer, but may permit removal of intermediate entries. The queue 306 may store requests 308 (shown individually as 308a, 308b, 308c, . . . , 308n). The requests 308 may be stored and/or indexed in an order of receipt by the platform 300. Each request 308 may be a code or pointer or other identifier for a customer in some cases. Each request 308 may be code or pointer or other identifier for a shopping cart data structure containing one or more product items in some cases.

In other cases, the queue 306 is not a discrete memory location storing requests, like a buffer or the like, but instead is implemented through assigning each request an index or other number representing a queue position. Put another way, the queue 306 may not be materialized as a single in-memory data structure (for example, in a contiguous portion of memory), but rather data may be assigned to each request corresponding to a notional queue. For example, the queue position may be represented by an index with each successive request being assigned a subsequent index in numerical series. In another example, the queue position may be represented as a bin or lot number wherein more than one request has the same bin or lot number and once a threshold number of requests are received, the bin or lot number is incremented and new requests are assigned the new bin or lot number. In some cases both systems are used, such that the bin or lot number represents a group of requests and each request in that bin or lot number has an ordered queue position in that bit or lot.

The assigned queue position may be represented by a token or other indicia that is sent by the platform to the requesting device. The requesting device may return the token or other indicia with subsequent requests or polling messages in order to prove its queue position. The queue manager 302 may require that requesting devices periodically or intermittently send a polling message to the queue manager 302 to inquire as to whether they are permitted to transition to the next stage of the checkout process, in some cases. In some other cases, the queue manager 302 may send a notification or other message to a requesting device when that requesting device's product request has reached a queue position that entitles it to advance to the next stage of the checkout process.

Other mechanisms and processes for assigning and managing queue position and state transitions for product requests may be used in some implementations.

For ease of discussion, the present description will refer to the “queue 306”, but it will be understood that not all implementations necessarily use a buffer or data structure in memory to store product requests, and queue position may be assigned and managed in tracked in a distributed/non-materialized manner, such as is described above.

The queue manager 302 may implement the queue 306 to manage throughput of product requests. That is, the queue 306 may serve to control the rate at which product requests are processed in the checkout phase, and/or total number of product requests permitted in the checkout phase at once, and/or the number of product requests transitioned to the checkout phase in any given time window. The purpose of the queue 306 may be to smooth out demand on the infrastructure that implements certain portions of the checkout phase, in some cases.

In one sense, the queue 306 serves as a notional “waiting room” in which prospective purchasers await the opportunity to proceed with the purchase process. The waiting room state may be reflected on a customer device 150 as a webpage, app page, or other GUI that may be accessed via a dedicated link relating to the upcoming event. Selection of the link or otherwise navigating to the waiting room GUI may include transmitting a message from the customer device 150 to the platform 300. In some cases, the message is a checkout request, such as through selection of a checkout button. Placement of the request in the queue 306 may be dependent upon the associated shopping cart containing a specific item associated with the queue 306 in some cases. In some other cases, queueing of the request occurs for any checkout request relating to a particular merchant. The GUI may signal to the customer device 150 that the customer checkout request is queued and awaiting permission to begin processing.

In some cases, position in the queue 306 may be determined based on the order in which requests 308 are received. In some cases, an initial queue position may be determined randomly in a “lottery” fashion, for those customers that initiate a checkout process at the time that the event (e.g. a flash sale) is initiated, or within a threshold (e.g., 10 seconds) time of the start of the event.

The queue 306 may be implemented at different phases of the online shopping process. In some implementations, the requests 308 in the queue 306 reflect requests to access a high demand product purchase page and are implemented prior to the customer adding a product item to a shopping cart. In some implementations, the requests 308 reflect the addition of a certain high demand product item to respective shopping carts prior to the check-out phase. In some implementations, the requests 308 reflect selection of a check-out phase in connection with carts containing a certain high demand product item. In some implementations, the requests 308 reflect selection of a payment request in association with a high demand product item. In some cases, the queue 306 may be specific to a high demand product item. In some cases, the queue 306 may be applied to all customers across a merchant channel irrespective of product items being requested due to a high demand event with respect to the merchant channel.

The queue manager 302 may handle the processing of requests 308 in an order determined by the queue 306 structure and/or policy. In some cases, the queue manager 302 changes the state associated with one or more queued requests 308 to indicate that they are permitted to be processed, but the requests 308 remain in the queue 306 until the associated customer device 150 sends a polling message requesting permission to continue with processing the request 308.

As requests 308 are processed, they are removed from the queue 306. The processing of a request 308 may include permitting access to a product purchase page, permitting the addition of a high demand product item to a shopping cart, permitting the transition to a check-out phase, permitting the initiation of a payment processing phase, or other steps in the purchase process.

In many cases, inventory for a high demand product item may be limited such that not all requests 308 will be fulfilled and result in a product purchase. Moreover, depending on how the queue 306 is implemented—i.e. at which phase of the purchase process-some requests 308 may not result in a completed purchase even if inventory is available because the associated customer may elect to discontinue the process or may lose connectivity or may otherwise abandon the purchase request prior to completion. In some cases, the platform 300 or external processes may terminate the purchase process prior to completion. For example, a payment processor may deny payment processing due to incorrect information, unavailable credit, or for fraud protection reasons, thereby cancelling the purchase process.

If inventory of the high demand product item is determined to be exhausted, then any remaining requests 308 in the queue 306 are refused. A message, GUI, or other signal may be sent by the platform 300 to the customer devices 150 corresponding to those requests 308 notifying them that their requests 308 have been refused and the product item is unavailable.

In at least some cases, it may be advantageous to proactively identify queued requests 308 that are unlikely to be completed so as to attempt to divert those requests 308, even before inventory is determined to be exhausted. For example, this may serve to increase throughput and/or the yield as regards successful processing of requests 308. Requests 308 may not eventually be successfully processed for a variety of reasons. For example, in some cases, those requests 308 that are unlikely to be completed may be due to factors associated with the customer, e.g., a history of high incidence of cart abandonment. Additionally or alternatively, in some cases, those requests 308 that are unlikely to be completed may be due to factors associated with the merchant, e.g., a comparison of available inventory to queue position of the request and a request completion rate. The assessment of whether a request is unlikely to be completed may, in some cases, be based on a determination of a likelihood of completion and comparison to a threshold value, and in some cases may be based on comparison of relative likelihoods of completion amongst queued requests, and in some cases may involve both. Accordingly, the queue manager 302 may include a completion likelihood estimator 304. Although illustrated as part of the queue manager 302 in this example, the completion likelihood estimator 304 may be implemented as a standalone application, service, or module, or as a part of another application or service within the platform 300. The completion likelihood estimator 304 determines a likelihood of completion associated with a product request. The completion likelihood estimator 304 may have access to the stored data 134 on the platform 300, such as historical customer data (e.g., purchase history, cart abandonment history, credit score, purchase history with a particular merchant), merchant-specific data (e.g., purchase completion rate/cart abandonment rate, whether for a particular product or store-wide). The completion likelihood estimator 304 may take as inputs to its determination a number of factors. In a basic implementation, the determined likelihood may be based on the queue position of a request and the inventory remaining for the requested product. The simplest determination is a binary “likely”/“unlikely” determination based on whether the number of requests ahead of the current request in the queue is greater than the available inventory.

The determination of likelihood of completion may be more complex in some implementations. For example, the determination may include determining a probability of abandonment of requests ahead of the current request in the queue, where “abandonment” refers to the termination of that product request either through action or inaction by the platform 300 or by the customer device 150 thereby resulting in an abandoned request. Abandonment of a product request may be intentional or unintentional. The determination of likelihood of completion may be based on the probability of abandonment, queue position, and inventory remaining. The determination of the probability of abandonment may be at least partly based on data regarding platform-wide or merchant-specific request abandonment rates. In some cases, the historical data on abandonment rates may be restricted to high-demand (e.g., flash sale) items.

In another example, the determination of likelihood of completion may be further based on a calculation of a probability of current product request abandonment, i.e., the probability that the product request will not be completed by the customer or by the platform. That calculation may take into account the customer history of product request completion or abandonment. The data may be restricted to past high-demand (e.g., flash sales) products, in some cases, or may be restricted to historical completion data relating to product requests for the same category or type of product. In some cases, the probability of current product request abandonment may be based on credit data regarding the customer.

In some implementations, machine learning techniques may be employed in estimating probabilities such as, for example, probabilities of abandonment such as, for example, based on prior high-demand scenarios (e.g., flash sales).

Howsoever the likelihood of completion is determined, the queue manager 302 may determine that the likelihood of completion for a current product request is lower than a threshold level, or is lower than other likelihoods of completion in the queue, and on that basis may take action to try to divert the current product request. Diversion may include identifying an alternative product item or offer and presenting the associated customer device with the identified alternative product item or offer. If accepted, then the current product request may be removed from the queue 306.

It will be appreciated that the identification of an alternative product item or offer, and presentation of that alternative product item or offer occurs prior to refusal of the current product request, i.e., prior to exhaustion of all inventory for high demand product items.

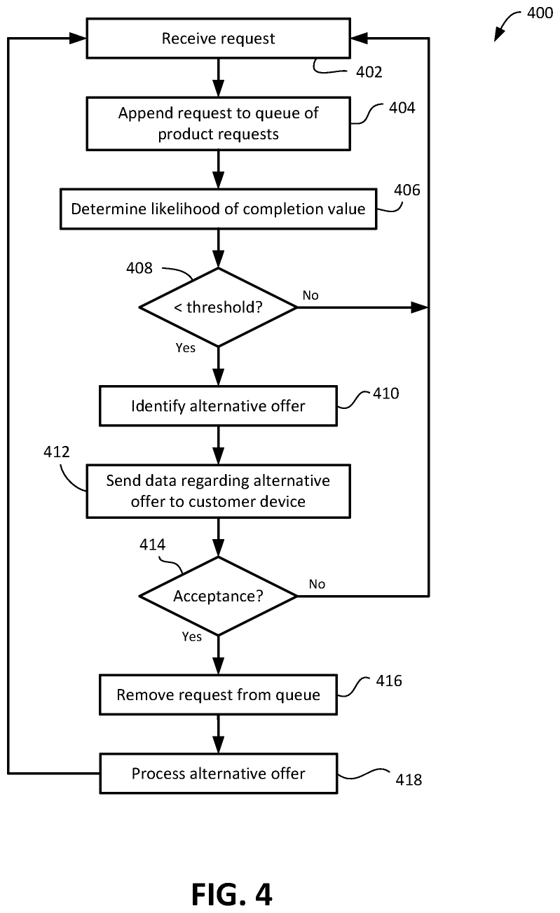

Reference is now made to FIG. 4, which shows, in flowchart form, one example method 400 of processing product requests with limited throughput. In this example, the product requests may be product purchase requests received by an e-commerce system. The method 400 may be implemented by a computing device having suitable computer-executable instructions for causing the computing device to carry out the described operations. The instructions may be implemented by way of a queue management module or application executing on a computing device. In some cases, the method 400 may be implemented, in whole or in part, by the commerce management engine 126 (FIG. 1), one of the services 116 (FIG. 1), or one of the applications 142A (FIG. 1).

The method 400 is carried out in the circumstances of a high-demand event, like a flash sale. The high demand event may be planned or unplanned and operation of the method 400 may be triggered as a scheduled event or may be triggered by detection of a high-demand load. The method 400 includes receiving a product request at the ecommerce system from a customer device in operation 402. The system appends the product request to a queue holding pending product requests in operation 404. As noted above, the queue may be a physical queue, e.g. a data structure storing product requests in memory, in some cases; however, in other cases the queue may be implemented by assigning each product request an index or other counter value reflecting its queue position without storing actual product requests as an ordered set in memory. Other mechanisms for tracking queue position may be used in other implementations.

In operation 406, the system determines a likelihood of completion value for the product request. The likelihood of completion value may be a probability calculation that the product request will result in a successful completed purchase of the product item that is the subject of the request. The value may be based on the queue position and an inventory count for the product item, in some cases. In some implementations, the value may be further based on customer purchase history data. In some implementations, the value may be further based on merchant product sales data. The history data and/or the sales data may include request abandonment data (e.g., a historical purchase request completion percentage).

Determining the likelihood of completion value may include obtaining customer data from stored data on the system, such as a database of customer purchase history. The customer data may be factored in the calculation of a completion probability. In some cases, instead of a completion probability, the system may determine a probability of cart abandonment for the present product request.

The likelihood of completion may take into account likelihood of running out of inventory, based on queue position and inventory plus a probability that purchasers earlier in the queue fail to complete their purchases, or fail to complete their purchases ahead of the current product request once both are accepted into the product purchase process. In one case, the number of people ahead of the current product request in the queue may be reduced proportional to an abandonment probability (e.g. 3%, for instance) to produce an adjusted count of requests in the queue ahead of the current product request. The adjusted count of requests may be compared to a current inventory level and if it exceeds the current inventory level the current product request may be designated as having a low probability of completion, i.e. a low likelihood of completion. The likelihood of completion may be binary (likely/unlikely) in some cases. In some cases, the likelihood of completion may be assigned a probability. The probability may be based on a probability distribution, e.g., Gaussian or otherwise, around the point where the inventory equals the adjusted count of requests.

In some cases, the likelihood of completion determined based on inventory, queue position, and probability of non-completion for requests having a more senior queue position may be further adjusted based on the probability that the current product request may be abandoned. That probability may be based on customer data associated with the current product request, such as historical customer purchase data for the account associated with the current product request. That stored customer data may include data regarding cart abandonment by the current account, which may be indicative of the likelihood of abandonment of the current cart, i.e., the probability that the product request will not be completed by the customer or by the platform. The data may be restricted to past high-demand (e.g., flash sales) products, in some cases, or may be restricted to historical completion data relating to product request for the same category or type of product.

In this example, the system assesses whether the likelihood of completion value is lower than a threshold value in operation 408. In the case where likelihood of completion is binary (likely/unlikely), then operation 408 may involve determining whether completion is likely or not. In the case where likelihood of completion is a probability value indicating a confidence, then the threshold value may be a minimum probability of completion value. For example, the system may set a minimum probability of 0.8 or 0.9 that a product request will lead to a successful purchase completion. If the likelihood of completion value meets or exceeds the threshold value, then the method 400 returns to operation 402 to receive another product request.

If the likelihood of completion value is below the threshold value then in operation 410 the system identifies an alternative offer. In some cases, the alternative offer may be pre-selected by the merchant. In some cases, the system may select from two or more pre-selected alternative offers. In some cases, the system may dynamically generate the alternative offer, subject to one or more constraints on permissible offers.

The alternative offer may, in some cases, be a different product item from the product item that is the subject of the product request. The alternative offer may be a credit, coupon, gift card, rebate, discount code or other such incentive offer. The alternative offer may be a token or code enabling the bearer to access a future event or offer.

In some implementations in which the system selects the alternative offer, the system may make the selection based on customer data associated with the product request. The customer data may provide information regarding the preferences or purchase history of the customer, or demographic data regarding the customer, that may be used as the basis for selecting the alternative offer. For example, the purchase history may indicate the customer has previously purchased certain products or types of products that indicate a more likely affinity for a first alternative offer than a second alternative offer. Or the purchase history may indicate the customer already has purchased one of the alternative items, which may indicate that the customer is likely to purchase it again, or may indicate that the customer is unlikely to want to purchase it again, depending on whether the item is of a type that is purchased repeatedly or purchased once or infrequently. As another example, the demographic data may indicate a customer age or location that may be used as the basis for selecting between alternative offers.

In operation 412, the system sends data regarding the alternative offer to the customer device associated with the product request. The data may be displayed on the customer device in any suitable manner, such as on a “waiting” page within a browser or app, as a pop-up window, as a notification or message in a messaging application, or otherwise. The display may include displaying actionable links or buttons or other elements enabling a user to accept or decline the alternative offer.

In operation 414, the system determines whether the alternative offer is accepted or declined. If declined, then the product request remains in the queue to await processing. If accepted, then in operation 416, the associated product request is removed from the queue and acceptance of the alternative offer is processed in operation 418. Processing of the alternative offer may vary depending on the nature of the offer. If the offer is purchase of an alternative item, then operation 418 may include adding the alternative item to a shopping cart data structure associated with the customer account, routing the customer's browsing session to a checkout page relating to the alternative item, and/or routing the customer's browsing session to a product details page relating to the alternative item and from which the customer may choose to add the item to a shopping cart.

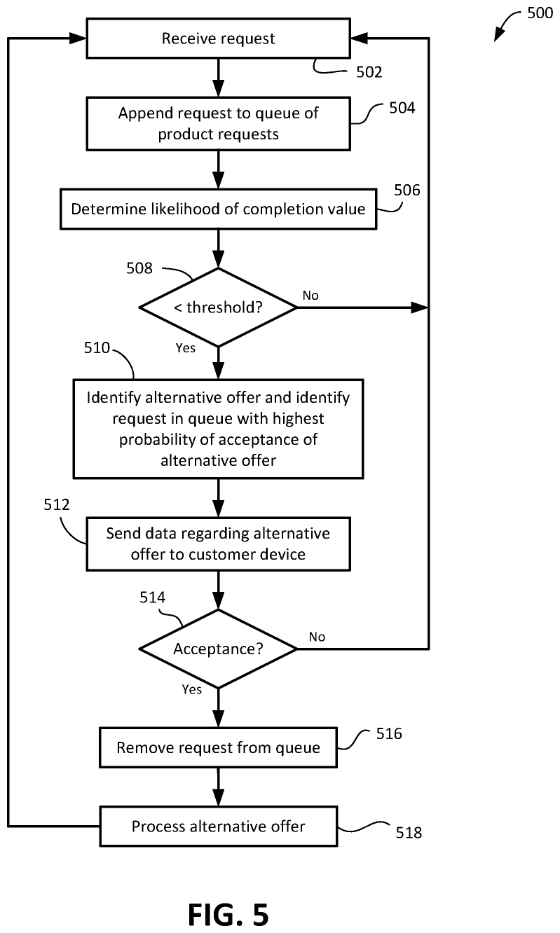

Reference is now made to FIG. 5, which shows another example method 500 of processing product requests with limited throughput. In this example, the product requests may be product purchase requests received by an e-commerce system. The method 500 may be implemented by a computing device having suitable computer-executable instructions for causing the computing device to carry out the described operations. The instructions may be implemented by way of a queue management module or application executing on a computing device. In some cases, the method 500 may be implemented, in whole or in part, by the commerce management engine 126 (FIG. 1), one of the services 116 (FIG. 1), or one of the applications 142A (FIG. 1).

In this example, the method 500 identifies when non-completion of purchases becomes a risk, as indicated by the likelihood of completion determination. In method 400 (FIG. 4) the system then identifies an alternative offer to which to present to the current product request in order to try to divert it; however in this example method 500, the system may attempt to divert a different product request in the queue. The system selects a product request to which to present the alternative offer based on an identification of which associated customer is most likely to accept the alternative offer.

The method 500 is carried out in the circumstances of a high-demand event, like a flash sale. The high demand event may be planned or unplanned and operation of the method 500 may be triggered as a scheduled event or may be triggered by detection of a high-demand load. The method 500 includes receiving a product request at the ecommerce system from a customer device in operation 502. The system appends the product request to a queue holding pending product requests in operation 504. As noted above, the queue may be a physical queue, e.g. a data structure storing product requests in memory, in some cases; however, in other cases the queue may be implemented by assigning each product request an index or other counter value reflecting its queue position without storing actual product requests as an ordered set in memory. Other mechanisms for tracking queue position may be used in other implementations.

In operation 506, the system determines a likelihood of completion value for the product request. The likelihood of completion value may be a probability calculation that the product request will result in a successful completed purchase of the product item that is the subject of the request. The value may be based on the queue position and an inventory count for the product item, in some cases. In some implementations, the value may be further based on customer purchase history data. In some implementations, the value may be further based on merchant product sales data. The history data and/or the sales data may include request abandonment data (e.g., a historical purchase request completion percentage).

Determining the likelihood of completion value may include obtaining customer data from stored data on the system, such as a database of customer purchase history. The customer data may be factored in the calculation of a completion probability. In some cases, instead of a completion probability, the system may determine a probability of cart abandonment for the present product request.

The likelihood of completion may take into account likelihood of running out of inventory, based on queue position and inventory plus a probability that purchasers earlier in the queue fail to complete their purchases, or fail to complete their purchases ahead of the current product request once both are accepted into the product purchase process. In one case, the number of people ahead of the current product request in the queue may be reduced proportional to an abandonment probability (e.g. 3%, for instance) to produce an adjusted count of requests in the queue ahead of the current product request. The adjusted count of requests may be compared to a current inventory level and if it exceeds the current inventory level the current product request may be designated as having a low probability of completion, i.e. a low likelihood of completion. The likelihood of completion may be binary (likely/unlikely) in some cases. In some cases, there likelihood of completion may be assigned a probability. The probability may be based on a probability distribution, e.g., Gaussian or otherwise, around the point where the inventory equals the adjusted count of requests.

In some cases, the likelihood of completion determined based on inventory, queue position, and probability of non-completion for requests having a more senior queue position may be further adjusted based on the probability that the current product request may be abandoned. That probability may be based on customer data associated with the current product request, such as historical customer purchase data for the account associated with the current product request. That stored customer data may include data regarding cart abandonment by the current account, which may be indicative of the likelihood of abandonment of the current cart, i.e., the probability that the product request will not be completed by the customer or by the platform. The data may be restricted to past high-demand (e.g., flash sales) products, in some cases, or may be restricted to historical completion data relating to product request for the same category or type of product.

In this example, the system assesses whether the likelihood of completion value is lower than a threshold value in operation 508. In the case where likelihood of completion is binary (likely/unlikely), then operation 508 may involve determining whether completion is likely or not. In the case where likelihood of completion is a probability value indicating a confidence, then the threshold value may be a minimum probability of completion value. For example, the system may set a minimum probability of 0.8 or 0.9 that a product request will lead to a successful purchase completion. If the likelihood of completion value meets or exceeds the threshold value, then the method 500 returns to operation 502 to receive another product request.

If the likelihood of completion value is below the threshold value then the system selects an alternative offer in operation 510. In some cases, the alternative offer may be pre-selected by the merchant. In some cases, the system may select from two or more pre-selected alternative offers. In some cases, the system may dynamically generate the alternative offer, subject to one or more constraints on permissible offers. The alternative offer may, in some cases, be a different product item from the product item that is the subject of the product request. The alternative offer may be a credit, coupon, gift card, rebate, discount code or other such incentive offer. The alternative offer may be a token or code enabling the bearer to access a future event or offer.

In operation 510, the system further determines a probability of acceptance of the alternative offer for at least some of the customers having product requests in the queue, such as the current product request and at least some of the product requests earlier in the queue. The probability of acceptance may be based on one or more non-customer-specific factors, such as current position in the queue, time spent in the queue, etc. In some cases, the probability of acceptance may be based on stored customer data for the accounts associated with the product requests. The stored customer data may provide data regarding whether the customer has accepted alternative offers in the past, whether the alternative offer is one associated with customer preferences or past purchases, whether the alternative offer is available to that customer based on age, location, membership status, or other factors. The customer data may be used as one or more factors in determining the probability of acceptance.

Having determined the probability of acceptance for at least two of the customers in the queue, the system identifies which customer has the highest probability of acceptance of the alternative offer. In some implementations, the system may not determine probability of acceptance for all customers in the queue. In some cases, the system may determine probability of acceptance for the current product request and for a subset of the other customer having product requests in the queue. The subset may be a fixed number in the queue immediately preceding the current request, as a fairness measure to avoid trying to divert customer that are substantially earlier in the queue, in some cases.

Having identified the customer most likely to accept the alternative item, in operation 512, the system sends data regarding the alternative offer to the customer device associated with that customer. The data may be displayed on the customer device in any suitable manner, such as on a “waiting” page within a browser or app, as a pop-up window, as a notification or message in a messaging application, or otherwise. The display may include displaying actionable links or buttons or other elements enabling a user to accept or decline the alternative offer.

In operation 514, the system determines whether the alternative offer is accepted or declined. If declined, then the associated product request for that customer remains in the queue to await processing. If accepted, then in operation 516, the associated product request is removed from the queue and acceptance of the alternative offer is processed in operation 518. Processing of the alternative offer may vary depending on the nature of the offer. If the offer is purchase of an alternative item, then operation 518 may include adding the alternative item to a shopping cart data structure associated with the customer account, routing the customer's browsing session to a checkout page relating to the alternative item, and/or routing the customer's browsing session to a product details page relating to the alternative item and from which the customer may choose to add the item to a shopping cart.

In one alternative implementation (not shown), operation 510 may include determining the probability of acceptance of the alternative offer for a plurality of customer having product requests in the queue, and the determined probability of acceptance values may be compared to a second threshold. If the probability of acceptance value exceeds the second threshold, then the alternative offer may be transmitted to that customer device. In some cases, this may result in multiple alternative offers being issued. In some cases, the determination of whether to send the alternative offer may depend on both the likelihood of completion value and the probability of acceptance. In one example, the likelihood of completion value may be compared to the probability of acceptance and, if lower, then the alternative offer may be sent.

In another alternative implementation (not shown), operation 510 includes selecting an alternative offer for each customer for which a probability of acceptance is to be determined. In other words, the alternative offer may be personalized or customized to the customer, meaning different alternative offers may be issued. The probability of acceptance determined for a customer may then be specific to the probability that this particular customer is going to accept the alternative offer selected by the system based on one or more of this particular customer's characteristics (e.g., purchase history, demographics, geography, etc.).

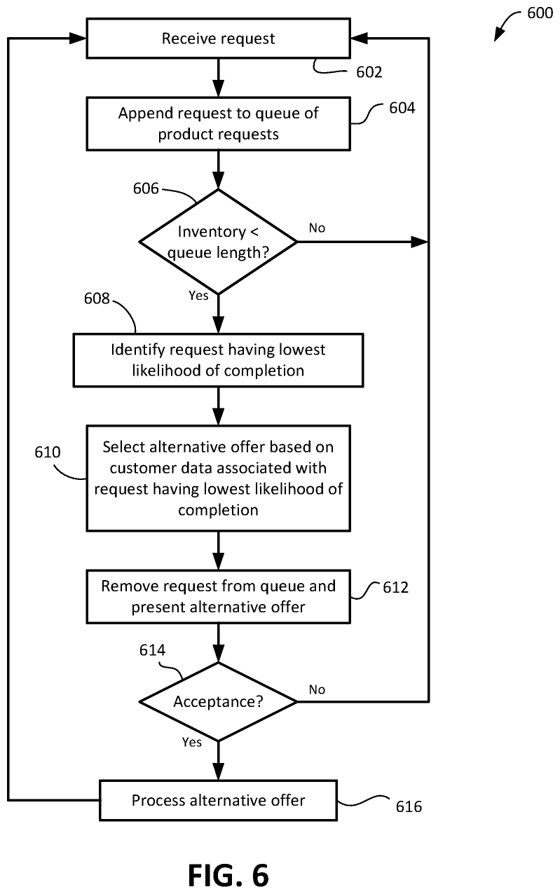

Reference is now made to FIG. 6, which shows, in flowchart form, a further example method 600 of processing product requests with limited throughput. In this example, the product requests may be product purchase requests received by an e-commerce system. The method 600 may be implemented by a computing device having suitable computer-executable instructions for causing the computing device to carry out the described operations. The instructions may be implemented by way of a queue management module or application executing on a computing device. In some cases, the method 600 may be implemented, in whole or in part, by the commerce management engine 126 (FIG. 1), one of the services 116 (FIG. 1), or one of the applications 142A (FIG. 1).

In this example method 600, the trigger for diversion is determination that inventory level has fallen below the count of queued product requests, and on that basis, a product request is identified in the queue with the lowest likelihood of completion. The alternative item is then identified based on the customer associated with that lowest likelihood of completion.

The method 600 is carried out in the circumstances of a high-demand event, like a flash sale. The high demand event may be planned or unplanned and operation of the method 600 may be triggered as a scheduled event or may be triggered by detection of a high-demand load. The method 600 includes receiving a product request at the ecommerce system from a customer device in operation 602. The system appends the product request to a queue holding pending product requests in operation 604. As noted above, the queue may be a physical queue, e.g. a data structure storing product requests in memory, in some cases; however, in other cases the queue may be implemented by assigning each product request an index or other counter value reflecting its queue position without storing actual product requests as an ordered set in memory. Other mechanisms for tracking queue position may be used in other implementations.

In operation 606, the system determines that the inventory count for the product that is the subject of the request is lower than the count of product requests in the queue. In some cases, the count of product requests may be an adjusted count of product requests, where the adjustment reduces the count proportional to a likelihood of abandonment of product requests.

If the inventory count is lower than the queue count in operation 606, then in operation 608 the system identifies a product request in the queue with the lowest likelihood of completion value associated with that product request. The likelihood of completion value may be a probability calculation that the product request will result in a successful completed purchase of the product item that is the subject of the request. The value may be based on the queue position and an inventory count for the product item, in some cases. In some implementations, the value may be further based on customer purchase history data. In some implementations, the value may be further based on merchant product sales data. The history data and/or the sales data may include request abandonment data (e.g., a historical purchase request completion percentage).

Determining the likelihood of completion value may include obtaining customer data from stored data on the system, such as a database of customer purchase history. The customer data may be factored in the calculation of a completion probability.

The determined likelihoods of completion are compared to identify the lowest likelihood of completion, i.e. the lowest probability of purchase completion. In some implementations, the system may not determine likelihood of completion for all purchase requests in the queue. In some cases, the system may determine likelihood of completion for the current product request and for a subset of the other product requests in the queue. The subset may be a fixed number in the queue immediately preceding the current request in some cases. The subset may include product requests received within a certain time window, e.g., the past 2 seconds, 5 seconds, or 10 seconds. Other mechanisms for determining the subset may be used.

Once the system identifies the product request having the lowest associated likelihood of completion in operation 608, then the system selects an alternative offer based on the customer associated with the lowest likelihood of completion, as indicated by operation 610. The alternative offer may be selected based on customer data, such as purchase history, demographics, geographical location, or other such factors. In some cases, the alternative offer may be pre-selected by the merchant. In some cases, the system may select from two or more pre-selected alternative offers. In some cases, the system may dynamically generate the alternative offer, subject to one or more constraints on permissible offers. The alternative offer may, in some cases, be a different product item from the product item that is the subject of the product request. The alternative offer may be a credit, coupon, gift card, rebate, discount code or other such incentive offer. The alternative offer may be a token or code enabling the bearer to access a future event or offer.

In some implementations, the customer data may provide information regarding the preferences or purchase history of the customer that may be used as the basis for selecting the alternative offer. For example, the purchase history may indicate the customer has previously purchased certain products or types of products that indicate a more likely affinity for a first alternative offer than a second alternative offer. Or the purchase history may indicate the customer already has purchased one of the alternative items, which may indicate that the customer is likely to purchase it again, or may indicate that the customer is unlikely to want to purchase it again, depending on whether the item is of a type that is purchased repeatedly or purchased once or infrequently. As another example, the demographic data may indicate a customer age or location that may be used as the basis for selecting between alternative offers.

In this example, the system sends data regarding the alternative offer to the customer device associated with the product request and proactively removes the product request from the queue. In some implementations, the system may await acceptance of the alternative offer before removing the product request from the queue, but in this example the product request is automatically removed once it has been identified as the one with the lowest likelihood of completion.

The alternative offer data may be displayed on the customer device in any suitable manner, such as on a “waiting” page within a browser or app, as a pop-up window, as a notification or message in a messaging application, or otherwise. The display may include displaying actionable links or buttons or other elements enabling a user to accept or decline the alternative offer.

In operation 614, the system determines whether the alternative offer is accepted or declined. If declined, then the method 600 returns to operation 602. If accepted, then acceptance of the alternative offer is processed in operation 616. Processing of the alternative offer may vary depending on the nature of the offer. If the offer is purchase of an alternative item, then operation 616 may include adding the alternative item to a shopping cart data structure associated with the customer account, routing the customer's browsing session to a checkout page relating to the alternative item, and/or routing the customer's browsing session to a product details page relating to the alternative item and from which the customer may choose to add the item to a shopping cart.

In the foregoing examples, the likelihood of completion may be described as being determined upon receipt of the request. In some cases, it may be determined by the system at a different time, such as when the request is added to a cart. It may be determined once on receipt of the request and then updated or re-determined at a later time. In some cases, the likelihood of completion for each queued product request is re-determined with each received request. In some cases, the likelihood of completion of each queued product request is re-determined after any product request is removed due to acceptance of an alternative offer. In some cases, only product requests after the removed product requests have their associated likelihoods of completion re-determined. Other triggers and/or frequencies of determination or re-determination may be used in other implementations.

It will be understood that some of the operations of the example methods 400, 500, and 600 may be performed in a different order or simultaneously without materially impacting operation of the methods.

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g. Long Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method of processing high frequency requests in a computing system, the method comprising:
receiving, by the computing system, a product request for an item;
appending the product request to an ordered queue of requests for processing;
determining a likelihood of completion value for the product request; and,
when the likelihood of completion value is less than a threshold level,
identifying an alternative offer, and
generating and sending, to a customer device, data regarding the alternative offer.

2. The computer-implemented method of claim 1, further comprising receiving an acceptance message from the customer device and, as a result, removing the product request from the ordered queue.

3. The computer-implemented method of claim 2, further comprising, in response to receiving the acceptance message, processing an alternative request for the alternative offer.

4. The computer-implemented method of claim 1, wherein the identifying the alternative offer includes determining that a completion probability with respect to the alternative offer exceeds a second threshold level.

5. The computer-implemented method of claim 1, wherein the identifying the alternative offer is based, at least in part, on merchant-selected alternative offers and customer data retrieved from a data storage device in the computing system.

6. The computer-implemented method of claim 1, wherein determining a likelihood of completion value includes determining the likelihood of completion value based on, at least, a queue position of the product request and an item inventory.

7. The computer-implemented method of claim 6, wherein determining the likelihood of completion value is further based on at least one of a customer history, a cart abandonment rate, likelihood of completion values associated with requests earlier in the queue, an item purchase history, or an alternative product purchase history.

8. The computer-implemented method of claim 1, wherein determining the likelihood of completion value includes determining respective likelihood of completion values for a subset of product requests in the queue and determining that the product request is associated with a lowest one of the respective likelihood of completion values.

9. The computer-implemented method of claim 1, wherein identifying an alternative offer includes determining a probability of acceptance of the alternative offer for a subset of customers having pending product requests in the ordered queue, identifying a particular customer as having a highest probability of acceptance, and wherein generating and sending includes generating and sending data regarding the alternative offer to the particular customer.

10. The computer-implemented method of claim 9, wherein the probability of acceptance for each customer in the subset of customers is at least partly based on stored customer data regarding that customer.

11. A computing system to process high frequency requests, the system comprising:
one or more processors;
memory storing customer data; and
a processor-readable storage medium containing processor-executable instruction that, when executed by the one or more processors, are to cause the one or more processors to:
receive, by the computing system, a product request for an item;
append the product request to an ordered queue of requests for processing;
determine a likelihood of completion value for the product request; and
when the likelihood of completion value is less than a threshold level identify an alternative offer, and
generate and send, to a customer device, data regarding the alternative offer.

12. The computing system of claim 11, wherein the instructions are to further cause the one or more processors to receive an acceptance message from the customer device and, as a result, remove the product request from the ordered queue.

13. The computing system of claim 12, wherein the instructions are to further cause the one or more processors to, in response to receiving the acceptance message, process an alternative request for the alternative offer.

14. The computing system of claim 11, wherein the instructions, when executed, are to cause the one or more processors to identify the alternative offer by determining that a completion probability with respect to the alternative offer exceeds a second threshold level.

15. The computing system of claim 11, wherein the instructions, when executed, are to cause the one or more processors to identify the alternative offer based, at least in part, on merchant-selected alternative offers and customer data retrieved from the memory.

16. The computing system of claim 11, wherein the instructions, when executed, are to cause the one or more processors to determine a likelihood of completion value by determining the likelihood of completion value based on, as least, a queue position of the product request and an item inventory.

17. The computing system of claim 16, wherein determining the likelihood of completion value is further based on at least one of a customer history, a cart abandonment rate, likelihood of completion values associated with requests earlier in the queue, an item purchase history, or an alternative product purchase history.

18. The computing system of claim 11, wherein the instructions, when executed, are to cause the one or more processors to determine a likelihood of completion value by determining respective likelihood of completion values for a subset of product requests in the queue and determining that the product request is associated with a lowest one of the respective likelihood of completion values.

19. The computing system of claim 11, wherein the instructions, when executed, are to cause the one or more processors to identify an alternative offer by determining a probability of acceptance of the alternative offer for a subset of customers having pending product requests in the ordered queue, identifying a particular customer as having a highest probability of acceptance, and wherein generating and sending includes generating and sending data regarding the alternative offer to the particular customer.

20. The computing system of claim 19, wherein the probability of acceptance for each customer in the subset of customers is at least partly based on stored customer data regarding that customer.

21. A non-transitory computer-readable medium storing processor-executable instructions for to processing high frequency requests, wherein the instructions, when executed by one or more processors, are to cause the one or more processors to:
receive, by the computing system, a product request for an item;
append the product request to an ordered queue of requests for processing;
determine a likelihood of completion value for the product request; and
when the likelihood of completion value is less than a threshold level identify an alternative offer, and
generate and send, to a customer device, data regarding the alternative offer.
